(19) United States
(12) Patent Application Publication
(10) Pub. No.: US 2014/0019436 A1
(43) Pub. Date: Jan. 16, 2014

(54) INFORMATION PROCESSING APPARATUS, INFORMATION PROCESSING SYSTEM, INFORMATION PROCESSING METHOD AND INFORMATION PROCESSING PROGRAM

(71) Applicant: Tadashi Sato, Tokyo (JP)

(72) Inventor: Tadashi Sato, Tokyo (JP)

(73) Assignee: NEC Corporation, Tokyo (JP)

(21) Appl. No.: 13/977,309

(22) PCT Filed: Jan. 6, 2012
(86) PCT No.: PCT/JP12/50647

§ 371 Date: Jun. 28, 2013

(30) Foreign Application Priority Data
Jan. 25, 2011 (JP) 2011-012946

(51) Int. Cl. G06F 17/30

(52) U.S. Cl. CPC G06F 17/30442
USPC 707/713

(57) ABSTRACT

An information processing apparatus receives a query specifying a value range; generates keys indicating values in the query; generates a key range (KR) group containing at least one KR which is a set of prescribed keys; stores a key indicating bounds of keys managed by each apparatus; receives the KR group; specifies, with respect to each KR in the received KR group, one key as an address key based on the relation between the value indicated by a prescribed key contained in the KR and the values indicated by each stored key respectively; appends the keys contained in the KR to a group of KR which is a set of keys associated with a node identifier of an apparatus identified based on the value of the specified address key; and forwards each group of KR to the apparatus identified by the node identifier associated with each group of KR respectively.

### TECHNICAL FIELD

The present invention relates to a forwarding method of queries in a structured P2P (Peer-to-Peer).

### BACKGROUND ART

In a structured P2P (Peer-to-Peer), nodes which constitute the structures P2P system share queries inputted from an external system and process the queries. The node is a program deployed on a memory which constitutes an apparatus that includes a CPU (Central Processing Unit). By the CPU reading and executing the program, a computer including this CPU functions as the node which forwards the queries, or holds data on the memory. By a value (key) generated from the query by such as a hash function, the node which the query should reach is determined. In the structured P2P, a key space which is a space representing an applicable value to the key is defined, and a part of the key space is assigned to each node as a range (key range). The key assigned to the node is called an assigned key of the node. The range of the assigned key is called an assigned key range. The key which indicates a smallest value within the assigned key range is called the smallest assigned key. The key which indicates a largest value within the assigned key range is called a maximum assigned key.

The query inputted from the external system is sent to the node to which the key generated from the query is assigned via nodes of no less than 0. Since there is a possibility that a plurality of keys is generated from the query, in that case, the query is sent to all of the nodes to which each key is assigned. Specifying the nodes to be passed depends on a routing protocol. When the query is sent to the node to which a certain key is assigned, the key is called an address key of the node.

When the data is inputted from the external system, the node generates the key from the data and sends the data to the node to which the generated key is assigned. Therefore, the data and the query for which the same key is generated are sent to the identical node to which the key is assigned. In case each node determines perfect matching of the data and the query, a structure which makes a value which is obtained by a hash function with the data as an input to be a key and which makes a value which is obtained by a hash function with the data designated by the query as an input to be a key, will do. By doing so, the data and the query which perfectly match each other reach to identical node.

A method which routes the query inputted from the external system to the node which should process the query is disclosed (for example, refer to NPL 1).

A technology disclosed in NPL 1 operates, for example, as follows. Each node of the P2P system maps an attribute value which indicates respective values representing a multidimensional attribute to a key which indicates one-dimensional data using a space filling curve. And, when a query is inputted, each node generates a key range which is a set of keys which indicate a certain value from the query. Next, the node decides the node of forwarding destination of the query so that the query may be sent to the node to which the smallest key in each key range is assigned. And, the node sends the query to the node of forwarding destination. The query is sent to the node to which the key is assigned via nodes of no less than 0. The node of forwarding destination of the query receives the query and processes the received query. At the time of the processing, in case a maximum value of the key range of the query is larger than a maximum value of the key range assigned to the node, the node forwards the received query to a successor. The successor of the node is a node to which a key which indicates a value which has added 1 to the maximum value of the respective values which the assigned keys of the node indicate is assigned. The processing in which the node forwards the query to the successor is repeated until the maximum value of the key range generated from the query becomes smaller than the maximum value of the key range assigned to the node.

### CITATION LIST

### Non Patent Literature

[NPL 1] Prasanna Ganesan et al., “One torus to rule them all: Multi-dimensional queries in p2p systems,” In WebDB '04: Proceedings of the 7th International Workshop on the Web and Databases, pages 19-24, New York, N.Y., USA, 2004. ACM Press.
[NPL 2] Christian Bohm et al., “XZ-Ordering: A Space-Filling Curve for Objects with Spatial Extension,” Proceedings of the 6th International Symposium on Advances in Spatial Databases, pages 75-90, Jul. 20-23, 1999.
[NPL 3] Ion Stoica et al., “Chord: A Scalable Peer-to-peer Lookup Service for Internet Applications,” In Proceedings of the 2001 Conference on Applications, Technologies, Architectures, and Protocols For Computer Communications. SIGCOMM '01. ACM, New York, N.Y., 149-160.

### SUMMARY OF INVENTION

### Technical Problem

The technology disclosed in NPL 1 divides the query into several key ranges without considering the assigned key range of the node through which the query is relayed and sends each key range. Therefore, in the node through which the query is relayed, there is a possibility that the identical query may pass the same node many times.

An example of the object of the present invention is to provide an information processing apparatus, an information processing system, an information processing method and an information processing program which reduces redundant query forwarding when forwarding large volumes of queries.

### Solution to Problem

An information processing apparatus in one aspect of the present invention includes: a key range generation unit for receiving a query which specifies a certain value range, generating keys which indicate values contained in the query respectively, and generating a key range group which contains at least one key range which is a set of prescribed keys; a path management unit for storing a key which indicates bounds of the keys to be managed by each apparatus; and a query forwarding control unit for receiving the key range group, specifying, with respect to each key range contained in the key range group, one key which is an address key on the basis of the magnitude relation between the value indicated by a prescribed key contained in the key range and the values indicated by each key which the path management unit stores, and appending the keys contained in the key range to a group of key range which is a set of keys each of which associated with a node identifier of an apparatus identified on the basis of the value of the address key; wherein the query forwarding control unit forwards each group of key range to the apparatus which is identified by the node identifier associated with each of the group of key range respectively.

An information processing system in one aspect of the present invention includes at least one information processing apparatus, wherein the information processing apparatus includes: a key range generation unit for receiving a query which specifies a certain value range, generating keys which indicate values contained in the query respectively, and generating a key range group which contains at least one key range which is a set of prescribed keys; a path management unit for storing a key which indicates bounds of the keys to be managed by each information processing apparatus; and a query forwarding control unit for receiving the key range group, specifying, with respect to each key range contained in the key range group, one key which is an address key on the basis of the magnitude relation between the value indicated by a prescribed key contained in the key range and the values indicated by each key which the path management unit stores, and appending the keys contained in the key range to a group of key range which is a set of keys each of which associated with a node identifier of an information processing apparatus identified on the basis of the value of the address key; wherein the query forwarding control unit forwards each group of key range to the information processing apparatus which is identified by the node identifier associated with each of the group of key range respectively.

An information processing method in one aspect of the present invention: receives a query which specifies a certain value range, generates keys which indicate values contained in the query respectively, generates a key range group which contains at least one key range which is a set of prescribed keys, stores a key which indicates bounds of the keys to be managed by each apparatus in a path management unit, receives the key range group, specifies, with respect to each key range contained in the key range group, one key which is an address key on the basis of the magnitude relation between the value indicated by a prescribed key contained in the key range and the values indicated by each key which is stored in the path management unit, appends the keys contained in the key range to a group of key range which is a set of keys each of which associated with a node identifier of an apparatus identified on the basis of the value of the address key, and forwards each group of key range to the apparatus which is identified by the node identifier associated with each of the group of key range respectively.

An information processing program in one aspect of the present invention makes a computer execute: processing for receiving a query which specifies a certain value range, generating keys which indicate values contained in the query respectively, and generating a key range group which contains at least one key range which is a set of prescribed keys; processing for storing a key which indicates bounds of the keys to be managed by each apparatus in a path management unit; processing for receiving the key range group, specifying, with respect to each key range contained in the key range group, one key which is an address key on the basis of the magnitude relation between the value indicated by a prescribed key contained in the key range and the values indicated by each key which is stored in the path management unit; processing for appending the keys contained in the key range to a group of key range which is a set of keys each of which associated with a node identifier of an apparatus identified on the basis of the value of the address key; and processing for forwarding each group of key range to the apparatus which is identified by the node identifier associated with each of the group of key range respectively.

A recording medium in one aspect of the present invention stores an information processing program which makes a computer execute: processing for receiving a query which specifies a certain value range, generating keys which indicate values contained in the query respectively, and generating a key range group which contains at least one key range which is a set of prescribed keys; processing for storing a key which indicates bounds of the keys to be managed by each apparatus in a path management unit; processing for receiving the key range group, and specifying, with respect to each key range contained in the key range group, one key which is an address key on the basis of the magnitude relation between the value indicated by a prescribed key contained in the key range and the values indicated by each key which is stored in the path management unit; processing for appending the key contained in the key range to a group of key range which is a set of keys each of which associated with a node identifier of an apparatus identified on the basis of the value of the address key; and processing for forwarding each group of key range to the apparatus which is identified by the node identifier associated with each of the group of key range respectively.

### Advantageous Effects of Invention

One example of the advantageous effect of the present invention is to be able to reduce redundant query processing when processing large volumes of queries.

### BRIEF DESCRIPTION OF DRAWINGS

FIG. 1 is a block diagram which indicates a structure of an information processing system according to the first exemplary embodiment of the present invention.

FIG. 2 is an example which indicates a two-dimensional attribute.

FIG. 3 is a figure which indicates an example of a procedure when the information processing system maps a multidimensional attribute into a key which indicates one-dimensional information using a space filling curve.

FIG. 4 is a block diagram which indicates a structure of a node according to the first exemplary embodiment of the present invention.

FIG. 5 is an example of information which a path management unit stores.

FIG. 6 is a figure which indicates an example of the smallest assigned key table which the smallest assigned key holding unit holds.

FIG. 7 is a block diagram which indicates a structure when a node includes an assigned key range storage unit 106 which stores an assigned key range of own ode.

FIG. 8 is a figure which indicates an example of a message which a query forwarding control unit generates.

FIG. 9 is a block diagram which indicates a program storing device which a node includes.

FIG. 10 is a flow chart which indicates an example of an outline of operation of a key range generation unit of a node according to the first exemplary embodiment of the present invention.

FIG. 11 is a flow chart which indicates an example of an outline of operation of a query forwarding control unit of a node according to the first exemplary embodiment of the present invention.

FIG. 12 is a flow chart which indicates an example of an outline of operation of generation processing of a pair by a query forwarding control unit of a node according to the first exemplary embodiment of the present invention.

FIG. 13 is a specific example which indicates an outline of operation of a node according to the first exemplary embodiment.

FIG. 14 is a block diagram which indicates a structure of a node according to the second exemplary embodiment of the present invention.

FIG. 15 is a block diagram which indicates a program storing device which a node includes.

### DESCRIPTION OF EMBODIMENTS

Embodiments for carrying out the present invention will be described in detail with reference to drawings. In each drawing and in each exemplary embodiment described in the description, same code is assigned to components which include a same function.

### First Exemplary Embodiment

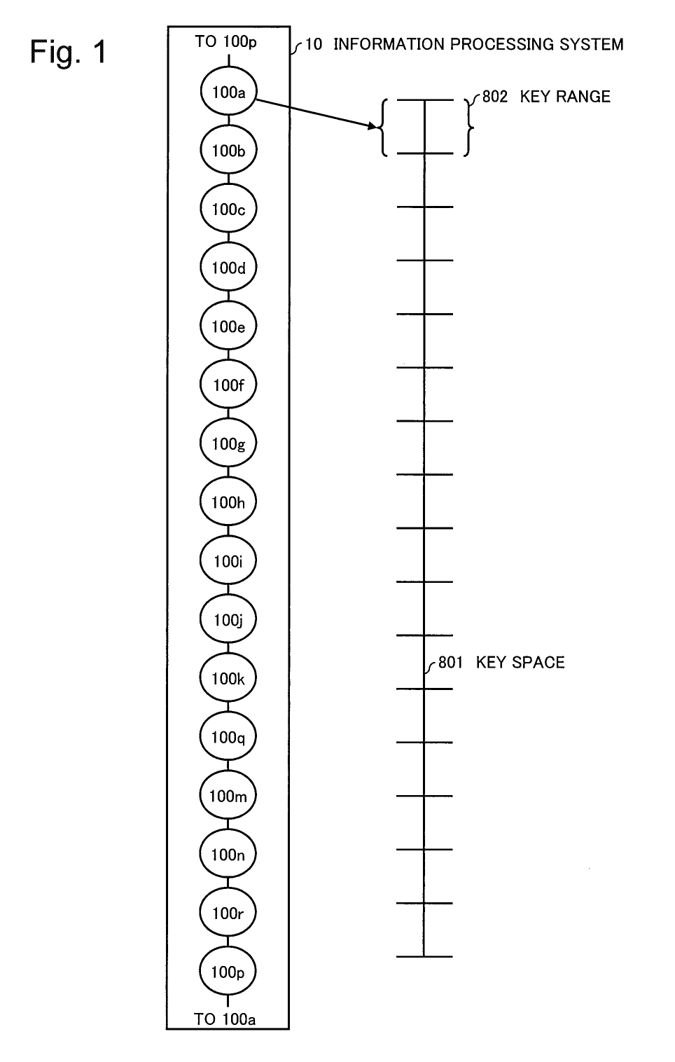

FIG. 1 is a block diagram which indicates a structure of an information processing system 10 according to the first exemplary embodiment of the present invention.

Referring to FIG. 1, the information processing system 10 according to the first exemplary embodiment of the present invention includes a plurality of nodes 100a to 100r. Here, nodes 100a to 100r are also described hereinafter as a node 100. Each node 100 is connected to at least one other node 100 so that they can communicate.

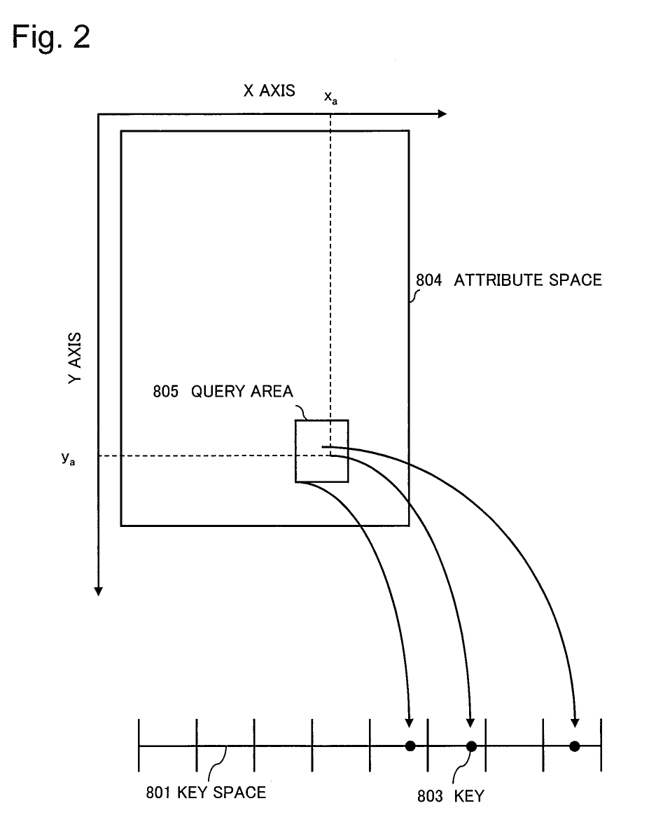

The information processing system 10 maps a multidimensional attribute into a key which indicates a certain value using a space filling curve. FIG. 2 is an example which indicates a two-dimensional attribute. A combination of respective attribute values in the two-dimensional attribute is mapped to a certain key 803. For example, in FIG. 2, a combination (xa, ya) of certain attribute values contained in a query area 805 which indicates at least part of an attribute space 804 which is a space composed of the two-dimensional attribute is mapped to the certain key 803.

In FIG. 1, the information processing system 10 includes from node 100a to node 100r. And, a key range 802 which is a part of a one-dimensional key space 801 is assigned to the respective nodes 100.

In this description, data may include a plurality of attributes. For example, the data may include a “latitude” attribute and a “longitude” attribute as location information. The attribute includes an attribute name which is information which identifies a class of the attribute and a value for the attribute name (attribute value). For example, the “latitude” attribute may include the attribute name “latitude” and the attribute value “35 degrees, 40 minutes north latitude” respectively.

In this description, a query may be information which designates a range of the attribute value. For example, the query may be information which designates the range of each attribute value such as: from 35 degrees, 30 minutes north latitude to 35 degrees, 50 minutes north latitude; and from 139 degrees, 40 minutes east longitude to 139 degrees, 50 minutes east longitude. Data as “35 degrees, 40 minutes north latitude and 139 degrees, 46 minutes east longitude” is contained in the range designated by the query mentioned above. Therefore, the data coincides with the query mentioned above “from 35 degrees, 30 minutes north latitude to 35 degrees, 50 minutes north latitude; and from 139 degrees, 40 minutes east longitude to 139 degrees, 50 minutes east longitude”.

Next, a procedure which the information processing system 10 maps a multidimensional attribute into a key which indicates one-dimensional information using a space filling curve will be explained.

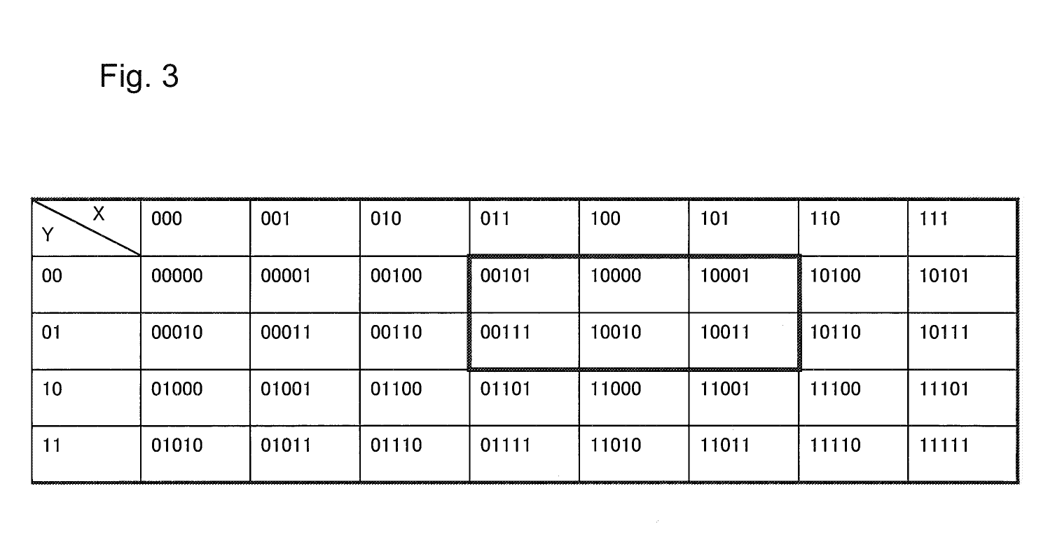

FIG. 3 is a figure which indicates an example of a procedure when the information processing system 10 maps a multidimensional attribute into a key which indicates one-dimensional information using a space filling curve.

This example is an example in which a two-dimensional attribute including an attribute x and an attribute y is mapped into a key which indicates one-dimensional information. First, from an attribute value range of the attribute x and an attribute value range of the attribute y, an attribute x subkey range [011, 101] and an attribute y subkey range [00, 01] are generated. Here, the subkey is a value which is used to generate the key. In the example of FIG. 3, the subkey of the attribute x is 3 bits. Also, the subkey of the attribute y is 2 bits. In this example, a bit string which lined alternately each bit for all combinations of a subkey set {011, 100, 101} contained in the attribute x subkey range and a subkey set {00, 01} contained in the attribute y subkey range will be the key. For example, when each bit of “011” and “00” are lined alternately, “00101” is generated. By the processing mentioned above, 2×3 (=6) keys are generated from the attribute value range of the attribute x and the attribute value range of the attribute y. In this description, to generate a key from “011” and “00” which is a combination of the subkeys is written as “to generate a key from (011, 00)”. The key generation method mentioned above is an illustration, and the key generation method may be a method in which the key is generated on the basis of a combination of bits contained in the subkey set.

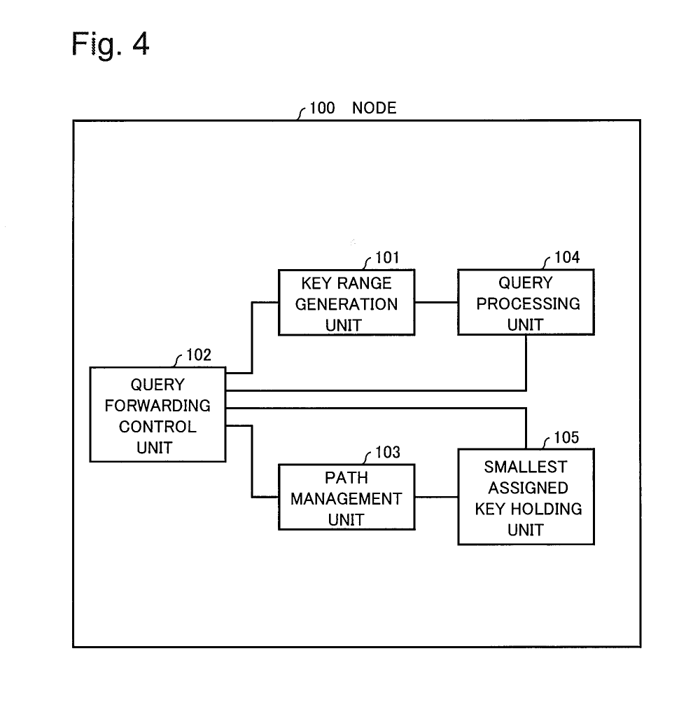

FIG. 4 is a block diagram which indicates a structure of the node 100 according to the first exemplary embodiment of the present invention.

Referring to FIG. 4, the node 100 according to the first exemplary embodiment of the present invention includes a key range generation unit 101, a query forwarding control unit 102, a path management unit 103, a query processing unit 104 and the smallest assigned key holding unit 105.

The key range generation unit 101 receives a query from an external system which is not illustrated. And, the key range generation unit 101 generates from the query data of a key range group which contains one or a plurality of key ranges. The key range is a range of a part of the key space which is a space of values which the key can take. Values of each key contained in a certain key range indicate a continuous value.

As a method in which the key range generation unit 101 generates the key range group from the query, means which NPL 2 discloses can be mentioned. For example, in case an area represented by the range of the latitude and the range of the longitude is designated as the query, by the method which NPL 2 discloses, processing is performed as follows. First, the key range generation unit 101 verifies, for all the areas which can be expressed by the latitude and the longitude, whether the area is contained completely in the query. When not contained, the key range generation unit 101 divides the area into four. With respect to each quartered area, in case one area overlaps with the query, the key range generation unit 101 divides the area further into four. The key range generation unit 101 performs the processing mentioned above recursively. When the processing mentioned above is completed, the key range generation unit 101 can obtain a set of the areas which are contained completely in the query and a set of the areas which do not overlap with the query. The key range generation unit 101 can generate one key range on the basis of the areas contained completely in the query. The means which NPL 2 discloses assumes that an attribute value of a plurality of attributes is converted into a one-dimensional key on the basis of a space filling curve so that a continuous key is generated from the divided areas.

The key range generation unit 101 divides, with respect to each generated key range, the key range into the key range which overlaps with an assigned key range of own node 100 and the key range which does not overlap. For example, the key range generation unit 101 divides it, on the basis of the smallest assigned key k in the assigned key range of own node 100, into the key range of a key which indicates values not less than k and the key range of a key which indicates values less than k. In other words, in case the key range [kₘᵢₙ, kₘₐₓ] contains the smallest assigned key k in the key range (assigned key range) assigned to own node 100 and a key k−1 which indicates a value smaller than the k by only 1, the key range generation unit 101 performs the following processing. That is, the key range generation unit 101 divides the key range [kₘᵢₙ, kₘₐₓ] into two of the key ranges [kₘᵢₙ, k−1] and [k, kₘₐₓ].

The key range generation unit 101 sends the query which own node 100 received and the key range group which contains the generated key ranges to the query forwarding control unit 102.

The query processing unit 104 receives the query from the query forwarding control unit 102 which will be described below and processes the received query. Processing which the query processing unit 104 performs is different depending on application methods of the information processing system 10. For example, the information processing system 10 can be used as a system of Publish/Subscribe type.

In the system of Publish/Subscribe type, an application registers a condition of data (condition of data corresponds to the query in the explanation so far) within the system in advance. When an event which coincides with the condition of data is generated, the event is notified to the application which registered the condition of data. That an event is inputted to the system is called as Publish. Also, that the condition of data is registered within the system is called as Subscribe.

In this exemplary embodiment, for example, a user registers the condition of data (data condition) within the information processing system 10 in advance. And, when data which matches with the data condition is inputted to the information processing system 10, the information processing system 10 notifies the data to an external system which registered the data condition. In this case, the data condition corresponds to the query. Therefore, the query processing unit 104 includes function means to store the query on a memory, and to perform coincidence determination of the query and the data when the data is inputted. After that, when the data is inputted to the query processing unit 104, the query processing unit 104 performs the coincidence determination with the query held on the memory. In case determined that they coincide, the query processing unit 104 notifies a prescribed notification destination to the effect.

The path management unit 103 calculates for a key (address key) an address (node address) of a node which is a next forwarding destination in order that the key reaches the node assigned. For example, the path management unit 103 calculates the node address on the basis of a routing protocol such as Chord (for example, refer to NPL 3). Chord is a protocol which specifies a node to which a key closest to the address key is assigned as the next forwarding destination.

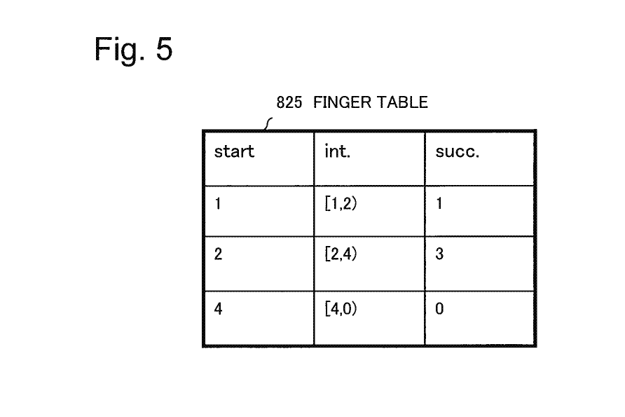

The path management unit 103 stores information which indicates a path to other node 100 (for example, in case of Chord, corresponds to Finger table). FIG. 5 is an example of information which the path management unit 103 stores. This information is also called as a finger table 825. In FIG. 5, “start” is a key which indicates a value which added by a prescribed number (for example, 2ⁱ, where i is an integer of no less than 0) to the value which the key associated with own node 100 indicates. Also, “int.” is information which indicates the key range corresponding to the key in “start”. For example, in a node which is associated with a key which is a key with the value of n, “start” is n+2ⁱ (provided that i is an integer of no less than 0). And, “int.” which is associated with the key “n+2ⁱ” is a set of the key k which satisfies n+2ⁱ<=k<2ⁱ1+1, that is, a key range of the key k. “succ.” is an identifier which indicates other node 100 associated with a key closest to the value of the key associated with start among the nodes corresponding to each key indicated by int. The key may be information which can identify either of nodes 100. Also, the key may be an identifier which can identify the node 100 or a node address. The key may be information which corresponds uniquely to the identifier which can identify a certain node or the node address.

In FIG. 5, “int.” may be information which indicates a set of keys associated with the nodes identified by “succ.” Also, the identifier of the node contained in “succ.” may be the node address of the node.

In order to generate information which indicates this path, each node 100 notifies other nodes 100 of the node address of own node 100 and the key assigned to own node. The path management unit 103 generates information which indicates the path to other nodes 100 on the basis of the information which is notified, and stores the information.

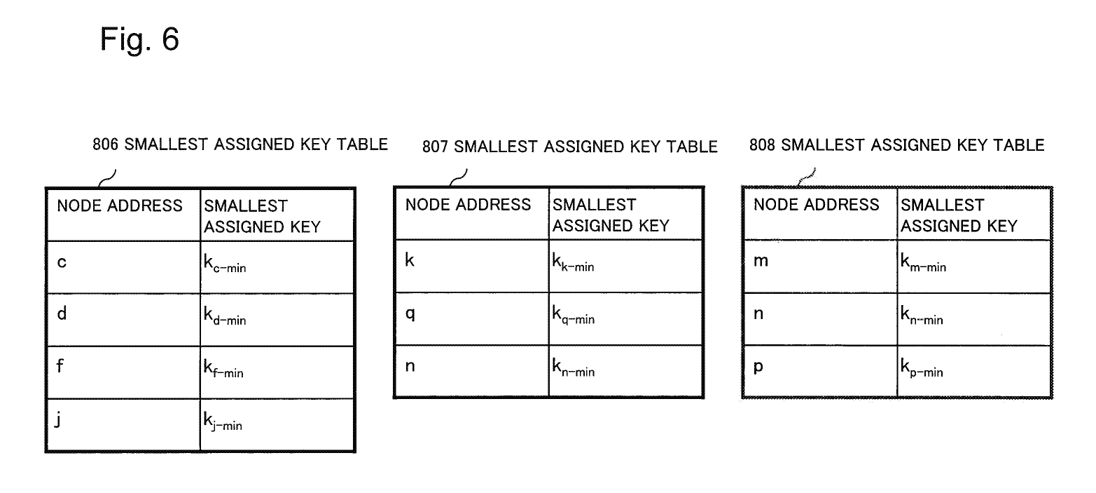

The smallest assigned key holding unit 105 holds the smallest assigned key of other nodes 100. Examples of the smallest assigned key table which the smallest assigned key holding unit 105 holds are indicated in FIG. 6. The examples indicated in FIG. 6 are the smallest assigned key table 806 which node 100b holds, the smallest assigned key table 807 which node 100j holds and the smallest assigned key table 808 which node 100q holds. Referring to FIG. 6, the smallest assigned key holding unit 105 of the node 100b stores that, for node addresses c, d, f and j, the smallest assigned keys of those nodes are k_{c-min}, k_{d-min}, k_{f-min} and kⱼ₋ₘᵢₙ respectively.

When the path management unit 103 generates the information which indicates the path to other node 100, the node 100 performs processing to notify the node address to different nodes 100. The smallest assigned key of the node 100 may be contained in the notification message. The smallest assigned key holding unit 105 associates the node address contained in the notification message which the path management unit 103 receives with the smallest assigned key, and stores them. As a result, when the path management unit 103 builds the information which indicates the path to other node 100, the smallest assigned key holding unit 105 can store the smallest assigned key table.

The query forwarding control unit 102 receives a query and a key range group from the key range generation unit 101 or the query forwarding control unit 102 of other node 100. And, the query forwarding control unit 102 verifies whether the assigned key range of own node overlaps with either of the key range groups. That is, the query forwarding control unit 102 verifies whether there exists among the keys contained in the key range group a key also contained in the assigned key range of own node.

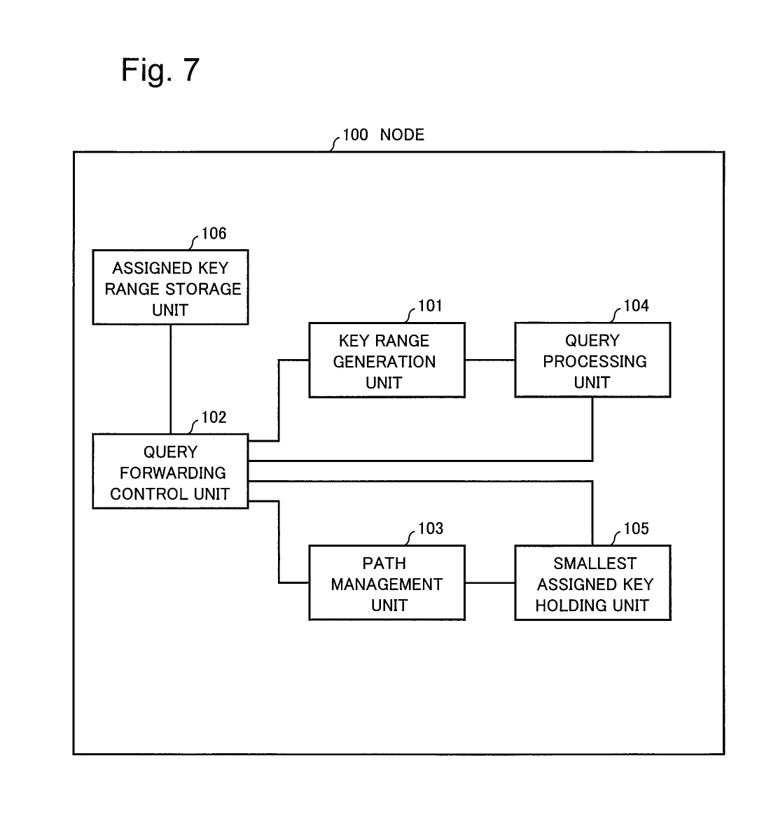

The assigned key range of own node may be stored in the query forwarding control unit 102. Or, as indicated in FIG. 7, the node 100 may include an assigned key range storage unit 106 which stores the assigned key range of own node.

In case the query forwarding control unit 102 determines that the assigned key range of own node overlaps with either of the key range groups, it sends the received query to the query processing unit 104. And, the query forwarding control unit 102 deletes the key range which is contained completely in the assigned key range from the key range group. For example, supposed that the assigned key range of own node is [k1, k2], and one key range within the key range group is [kₘᵢₙ, kₘₐₓ]. At that time, for example, the case of k1<=kₘᵢₙ<kₘₐₓ<=k2 falls under the example of “the key range which is contained completely in the assigned key range”, and this key range [kₘᵢₙ, kₘₐₓ] is deleted.

Also, the query forwarding control unit 102 divides, within the key range group, the key range which overlaps with the assigned key range of own node into two key ranges. And, the query forwarding control unit 102 deletes a part of key ranges which overlap with the assigned key range of own node, among the divided key ranges. For example, suppose that, among the keys contained in the assigned key range of own node, a largest assigned key which is a key indicating a maximum value is k. And, when the relation such as kₘᵢₙ<k<=kₘₐₓ is satisfied for the key range [kₘᵢₙ, kₘₐₓ], the query forwarding control unit 102 divides the key range [kₘᵢₙ, kₘₐₓ] into two key ranges [kₘᵢₙ, k] and [k+1, kₘₐₓ]. Also, the query forwarding control unit 102 deletes the key range [kₘᵢₙₙ, k].

The query forwarding control unit 102 generates a pair which associates a group of key range which is a set including the key range of no less than one with the node address of the node which is a destination of the group of key range. The query forwarding control unit 102 performs processing indicated below with respect to each key range [kₘᵢₙ, kₘₐₓ] of which the key range group is composed.

First, the query forwarding control unit 102 refers to the path management unit 103 and acquires the node address “addr” specified on the basis of kₘₐₓ. Next, the query forwarding control unit 102 reads the smallest assigned key k associated with the node address “addr” from the smallest assigned key holding unit 105.

And, the query forwarding control unit 102 specifies, among the key range [kₘᵢₙ, kₘₐₓ], a key of the key range [k, kₘₐₓ] which indicates values which are no less than the value which the read smallest assigned key k indicates and are no more than the value which kₘₐₓ indicates. And, the query forwarding control unit 102 appends this specified key to the group of key range which is sent to the node address “addr”. And, the query forwarding control unit 102 regards the remaining key range [kₘᵢₙ, k−1] as [kₘᵢₙ, kₘₐₓ] newly, and the processing mentioned above is repeatedly performed.

On the other hand, in case the query forwarding control unit 102 determined that the value which kₘᵢₙ indicates is smaller than the value which the read smallest assigned key k indicates, it specifies that the key range [kₘᵢₙ, kₘₐₓ] is contained in the group of key range sent to the node address “addr”. In case there are no key range groups corresponding to “addr”, the query forwarding control unit 102 generates a group of key range newly. And, the query forwarding control unit 102 specifies the group of key range as the group of key range which is sent to “addr”.

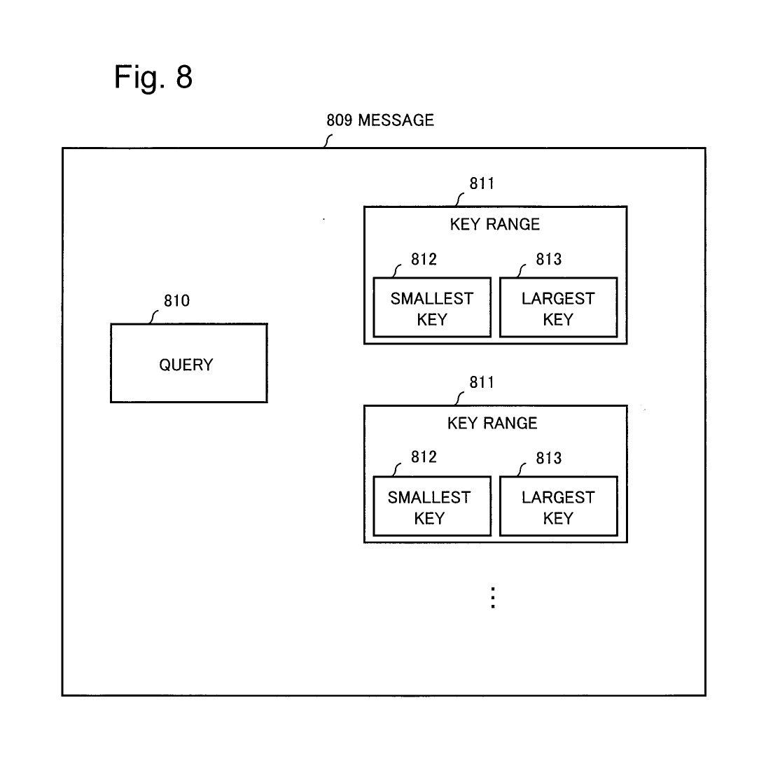

The query forwarding control unit 102 sends, with respect to each specified group of key range, the group of key range to the node 100 which is specified by the node address “addr” associated with each of the group of key range. Specifically, the query forwarding control unit 102 generates a message of the structure indicated in FIG. 8 with respect to each generated pair. This message 809 contains a query 810, each key range 811 contained in a group of key range, a smallest key 812 and a largest key 813 within each key range. The smallest key 812 is a key which indicates a smallest value among the keys contained in the key range. Also, the largest key 813 is a key which indicates a maximum value among the keys contained in the key range.

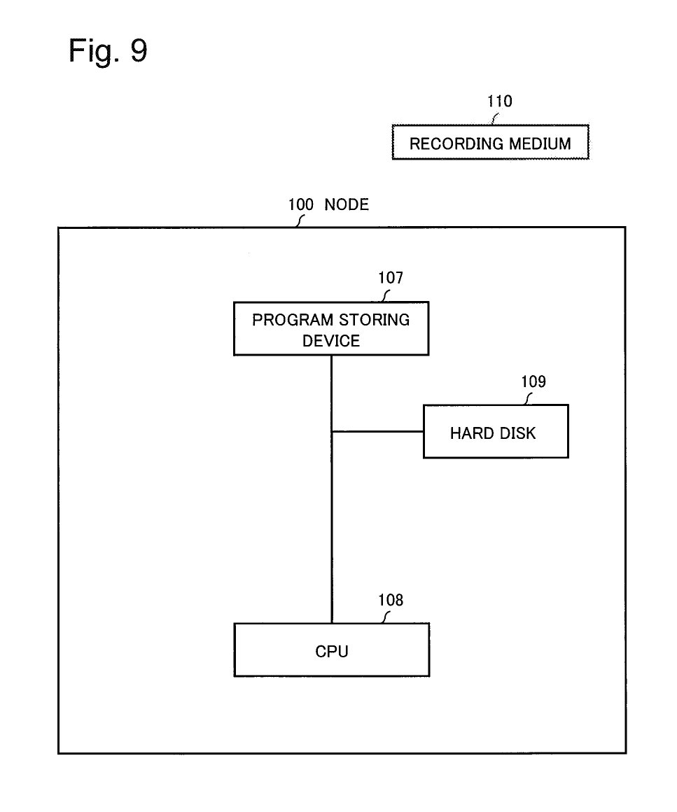

The key range generation unit 101, the query forwarding control unit 102, the path management unit 103 and the query processing unit 104 are, for example, realized by a CPU which operates by a program (information processing program). The key range generation unit 101, the query forwarding control unit 102, the path management unit 103 and the query processing unit 104 may be realized by the identical CPU. In this case, the program is, for example, stored in a program storing device 107 (refer to FIG. 9) included in the node 100. A CPU 108 may read the program and operate as the key range generation unit 101, the query forwarding control unit 102, the path management unit 103 and the query processing unit 104 following the program.

Also, a storage medium (or recording medium) 110 in which a code of the program mentioned above is recorded may be supplied to the node 100, and the node 100 may read and execute the code of the program stored in the recording medium. That is, the present invention also includes the recording medium 110 which stores temporarily or stores permanently software (information processing program) for the node 100 according to the first exemplary embodiment to execute.

The smallest assigned key holding unit 105 is realized, for example, by a storage device such as a hard disk 109.

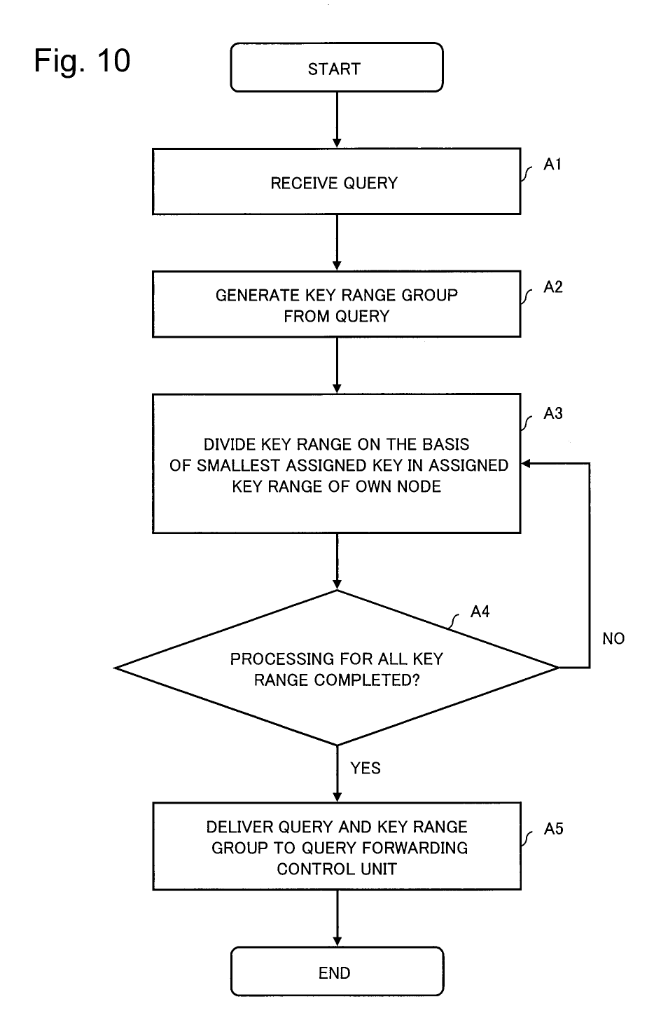

Next, an example of operation of the node 100 according to the first exemplary embodiment of the present invention will be described. FIG. 10 is a flow chart which indicates an example of an outline of operation of the key range generation unit 101 of the node 100 according to the first exemplary embodiment of the present invention.

The key range generation unit 101 receives a query from an external system which is not illustrated (Step A1). And, the key range generation unit 101 generates a key range group including a key range 1, a key range 2 and a key range 3 from the inputted query (Step A2).

The key range generation unit 101 performs the following processing with respect to each generated key range. Suppose that a certain key range is [kₘᵢₙ, kₘₐₓ]. In case the key range [kₘᵢₙ, kₘₐₓ] contains the smallest assigned key k in the assigned key range of own node 100 and a key k−1 which indicates a value smaller than the k by only 1, the key range generation unit 101 execute the following processing. That is, the key range generation unit 101 divides the key range [kₘᵢₙ, kₘₐₓ] into two on the basis of k (Step A3). Specifically, the key range generation unit 101 divides the key range [kₘᵢₙ, kₘₐₓ] into two key ranges [kₘᵢₙ k−1] and [k, kₘₐₓ].

The key range generation unit 101 determines whether the processing is performed for all key ranges or not (Step A4). In case the processing is performed not for all key ranges (No in Step A4), processing of the key range generation unit 101 returns to Step A3. In case the processing is performed for all key ranges (Yes in Step A4), the key range generation unit 101 performs the following processing. That is, the key range generation unit 101 sends the query which own node 100 received and the generated key range group to the query forwarding control unit 102 (step A5).

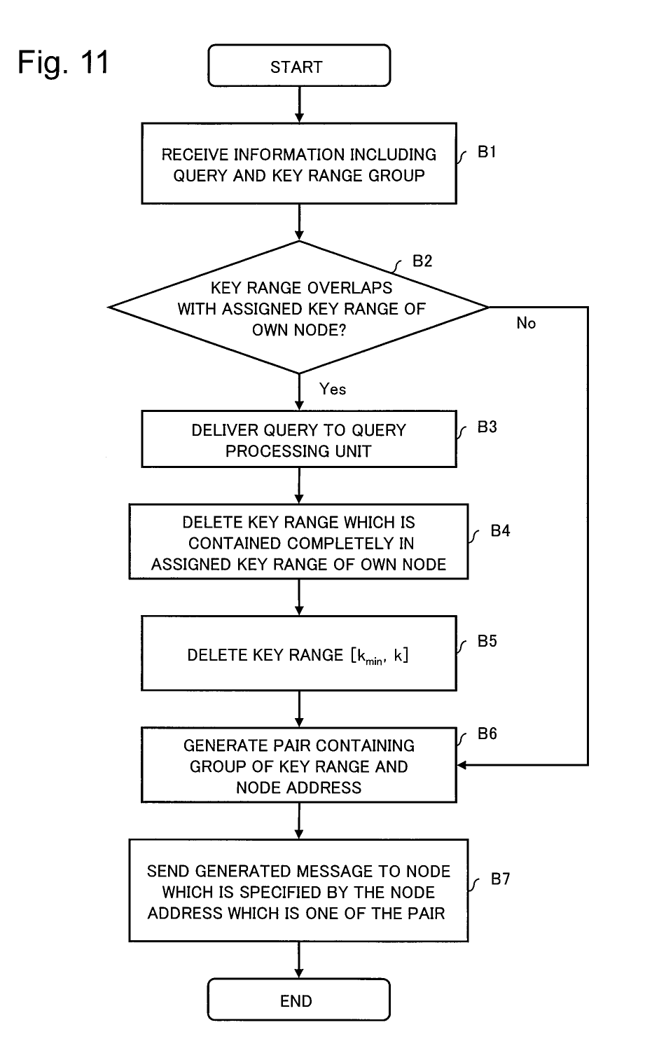

FIG. 11 is a flow chart which indicates an example of an outline of operation of the query forwarding control unit 102 of the node 100 according to the first exemplary embodiment of the present invention.

The query forwarding control unit 102 receives information including at least a query and a key range group from the key range generation unit 101 or the query forwarding control unit 102 of other node 100 (Step B1). And, the query forwarding control unit 102 verifies whether either of the key ranges which are contained in the received key range group overlaps with the assigned key range of own node 100 or not (Step B2).

In case the query forwarding control unit 102 determines that either of the key ranges which are contained in the received key range group overlaps with the assigned key range of own node 100 (Yes in Step B2), it sends the query to the query processing unit 104 (Step B3). And, the query forwarding control unit 102 deletes the key range which is contained completely in the assigned key range of own node 100 from each key range which is contained in the received key range group (Step B4). Also, the query forwarding control unit 102 divides, among each key range which is contained in the received key range group, the key range [kₘᵢₙ, kₘₐₓ] which overlaps with the assigned key range of own node 100 into two key ranges [kₘᵢₙ, k] and [k+1, kₘₐₓ]. And, the query forwarding control unit 102 deletes the key range [kₘᵢₙ, k] (step B5). Here, k is the largest assigned key of own node 100.

The query forwarding control unit 102 performs the following processing after the processing in step B5 or in case. The query forwarding control unit 102 determines that either of the key ranges which are contained in the key range group received in Step B2 does not overlap with the assigned key range of own node 100 (No in Step B2). That is, the query forwarding control unit 102 generates a pair of no less than 0 including a group of key range and a node address (Step B6). Processing of the query forwarding control unit 102 in Step B6 will be described later. The query forwarding control unit 102 generates, with respect to each generated pair, generates a message of the structure indicated in FIG. 8 on the basis of the query and the group of key range which is one part of the pair. And, the query forwarding control unit 102 sends the generated message to a node which is specified by the node address which is the other part of the pair (Step B7).

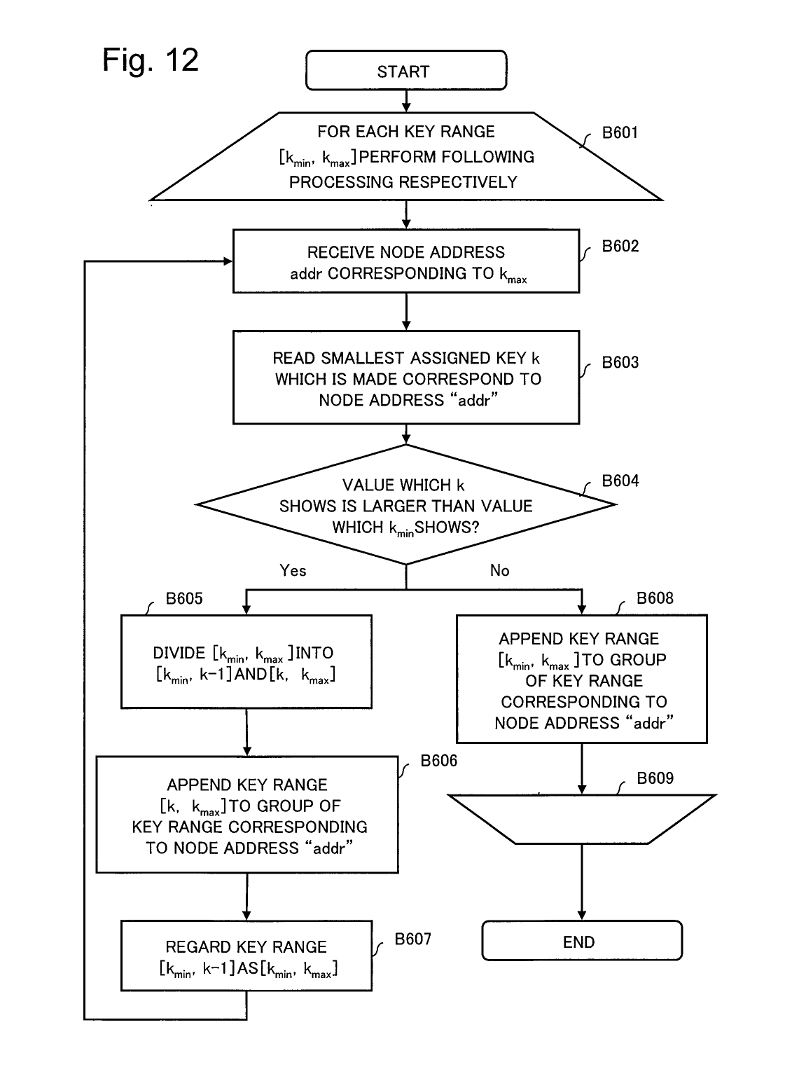

FIG. 12 is a flow chart which indicates an example of an outline of operation of the processing in step B6 mentioned above by the query forwarding control unit 102 of the node 100 according to the first exemplary embodiment of the present invention.

The query forwarding control unit 102 performs the following processing with respect to each key range [kₘᵢₙ, kₘₐₓ] generated by the steps so far (Step B601).

The query forwarding control unit 102 sends the key kₘₐₓ which indicates the maximum value among the keys contained in the key range to the path management unit 103 and receives the node address “addr” corresponding to the kₘₐₓ from the path management unit 103 (Step B602).

Next, the query forwarding control unit 102 reads the smallest assigned key k associated with the node address “addr” from the smallest assigned key holding unit 105 (Step B603).

The query forwarding control unit 102 determines whether the value which k indicates is larger than the value which kₘᵢₙ indicates or not (Step B604). In case it is determined that kₘᵢₙ<k (Yes in Step B604), the query forwarding control unit 102 divides the key range [kₘᵢₙ, kₘₐₓ] into two key ranges [kₘᵢₙ, k−1] and [k, kₘₐₓ] (Step B605).

Next, the query forwarding control unit 102 appends the key range [k, kₘₐₓ] to the group of key range corresponding to the node address “addr”. In case there exists no group of key range corresponding to “addr”, the query forwarding control unit 102 generates a group of key range newly and associates the group of key range with “addr” (Step B606). Hereinafter, the query forwarding control unit 102 regards the key range [kₘᵢₙ, k−1] as [kₘᵢₙ, kₘₐₓ] (Step B607). And, the processing of the query forwarding control unit 102 moves to Step B602.

On the other hand, in case the query forwarding control unit 102 determined that kₘᵢₙ>k (No in Step B604), the query forwarding control unit 102 appends the key range [kₘᵢₙ, kₘₐₓ] to the group of key range corresponding to the node address “addr”. In case no group of key range corresponding to “addr” exists, the query forwarding control unit 102 generates a group of key range newly and associates the group of key range with “addr” (Step B608).

The query forwarding control unit 102 performs the processing in Steps B602-B608 with respect to each key range (Step B609).

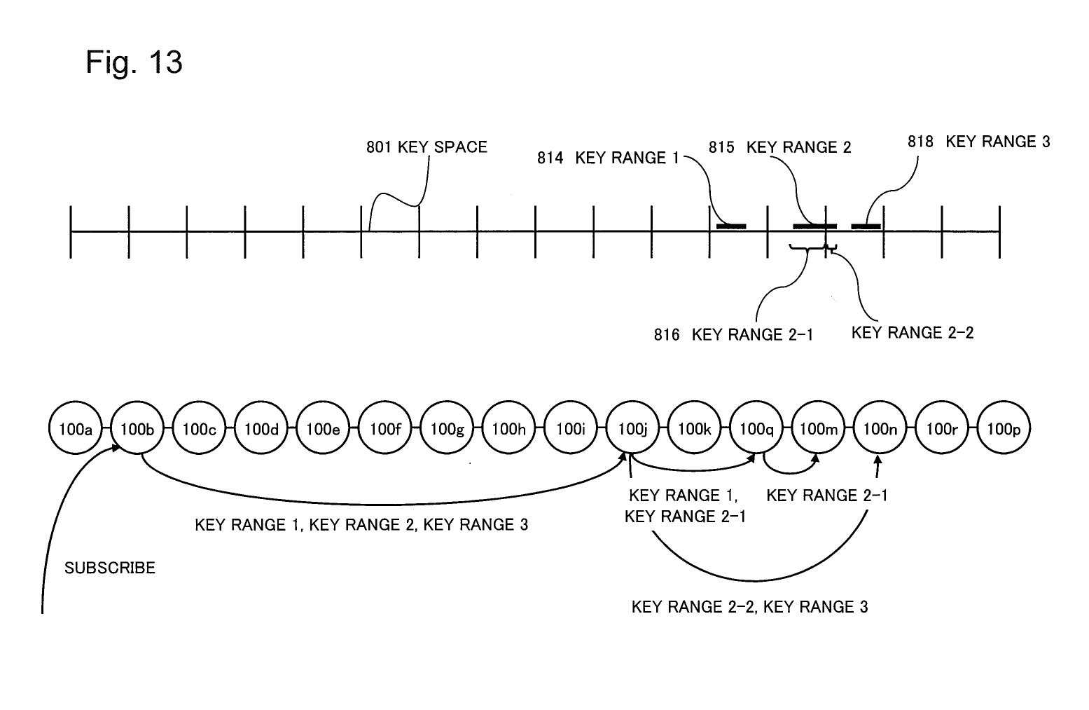

FIG. 13 is a specific example which indicates an outline of operation of the node 100b according to the first exemplary embodiment. In this case, the node 100b receives subscription of the query corresponding to a key range 1 (814), a key range 2 (815) and a key range 3 (818) and forwards them respectively.

The key range 1 (814) is represented as [k₁ₘᵢₙ, k₁ₘₐₓ]. And, the key range 1 (814) satisfies the relation such as k_{q-min}<k₁ₘᵢₙ<k₁ₘₐₓ<k_{q-max} for the assigned key range [k_{q-min}, k_{q-max}] of the node 100q. Also, the key range 2 (815) is represented as [k₂ₘᵢₙ, k₂ₘₐₓ]. And, the key range 2 (815) satisfies the following relation respectively for the assigned key range [kₘ₋ₘᵢₙ, kₘ₋ₘₐₓ] of the node 100m and the assigned key range [kₙ₋ₘᵢₙ, kₙ₋ₘₐₓ] of the node 100n. That is, the relation is the relation such as as kₘ₋ₘᵢₙ<k₂ₘᵢₙ<kₘ₋ₘₐₓ<kₙ₋ₘᵢₙ<k₂ₘₐₓ<kₙ₋ₘₐₓ. Also, the key range 3 (818) is represented as [k₃ₘᵢₙ, k₃ₘₐₓ]. Also, the key range 3 satisfies the relation such as kₙ₋ₘᵢₙ<k₃ₘᵢₙ<k₃ₘₐₓ<=kₙ₋ₘₐₓ for the assigned key range [kₙ₋ₘᵢₙ, kₙ₋ₘₐₓ] of the node 100n.

The key range generation unit 101 of the node 100b generates a key range group {key range 1, key range 2, key range 3} from the received query. There exists no key range which contains both of “k_{b-min}” which is the smallest assigned key of the node 100b and “k_{b-min}−1” in the key range group. Accordingly, there will be no division of the key range by the key range generation unit 101. After that, the key range generation unit 101 of the node 100b sends the query and the generated key range group {key range 1, key range 2, key range 3} to the query forwarding control unit 102.

The query forwarding control unit 102 of the node 100b receives the query and the key range group {key range 1, key range 2, key range 3} from the key range generation unit 101. Key ranges which overlap with the assigned key range [k_{b-min}, k_{b-max}] of the node 100b are not contained in the key range group. Accordingly, the query is not sended to the query processing unit 104.

Next, the query forwarding control unit 102 acquires a pair which associates the group of key range with the node address which can identify the node 100 to which the group of key range is sent on the basis of the received key range group. It is assumed that the smallest assigned key holding unit 105 of the node 100b holds, for example, the smallest assigned key table 806 indicated in FIG. 6.

It is assumed that the path management unit 103 will calculate a node address for one key according to a routing algorithm of Chord. In this case, the path management unit 103 includes node addresses of nodes which are only 2ⁱ (i is an integer of no less than 0) hops away from own node. For example, the path management unit 103 of the node 100b manages the node addresses of the node 100c, the node 100e, the node 100f and the node 100j. Also, the path management unit 103 stores, by associating it with the node addresses which its own manages, a set of the keys which correspond to each of them. For example, the path management unit 103 of the node 100b stores the keys contained in the respective assigned key ranges of the node 100j to the node 100p, and the node 100a by associating them with the node address of the node 100j.

For the key range 1, k₁ₘₐₓ is contained in the assigned key range of the node 100q. Also, the path management unit 103 stores the keys contained in the assigned key range of the node 100q by associating them with the node address of the node 100j. Therefore, by referring to the path management unit 103 for the key range 1, the query forwarding control unit 102 acquires the node address of the node 100j on the basis of k₁ₘₐₓ. Also, the query forwarding control unit 102 acquires the smallest assigned key kⱼ₋ₘᵢₙ of the node 100j from the smallest assigned key holding unit 105 on the basis of the node address of the node 100j.

Here, k₁ₘᵢₙ<kⱼ₋ₘᵢₙ does not hold. Therefore, the query forwarding control unit 102 appends the key range 1 [k₁ₘᵢₙ, k₁ₘₐₓ] to a group of key range j corresponding to the node address of the node 100j. The key range 2 and the key range 3 are appended to the group j same as the case of the key range 1.

Next, the query forwarding control unit 102 sends the query and the group of key range j {key range 1, key range 2, key range 3} to the node address of the node 100j.

The query forwarding control unit 102 of the node 100j receives the query and the key range group {key range 1, key range 2, key range 3} from the node 100b. No key range which overlaps with the assigned key range [kⱼ₋ₘᵢₙ, kⱼ₋ₘₐₓ] of the node 100j is contained in the key range group. Accordingly, the query is not sended to the query processing unit 104.

Next, the query forwarding control unit 102 acquires a pair which associates the group of key range with the node address which can identify the node 100 to which the group of key range is sent on the basis of the received key range group. It is assumed that the smallest assigned key holding unit 105 of the node 100j holds, for example, the smallest assigned key table 807 indicated in FIG. 6

It is assumed that the path management unit 103 of the node 100j also calculates the node address for one key according to the routing algorithm of Chord. For example, the path management unit 103 of the node 100j manages the node addresses of the node 100k, the node 100q, the node 100n and the node 100b. Also, the path management unit 103 stores, by associating it with the node addresses which its own manages, a set of the keys which correspond to each of them. For example, the path management unit 103 of the node 100j stores the keys contained in the respective assigned key ranges of the node 100q and the node 100m by associating them with the node address of the node 100q.

For the key range 1, k₁ₘₐₓ is contained in the assigned key range of the node 100q. Also, the path management unit 103 stores the key contained in the assigned key range of the node 100q by associating it with the node address of the node 100q. Therefore, by referring to the path management unit 103 for the key range 1, the query forwarding control unit 102 acquires the node address of the node 100q on the basis of k₁ₘₐₓ. Also, the query forwarding control unit 102 acquires a smallest assigned key k_{q-min} of the node 100q from the smallest assigned key holding unit 105 on the basis of the node address of the node 100q.

Here, k₁ₘᵢₙ<k_{q-min} does not hold. Therefore, the query forwarding control unit 102 appends the key range 1 [k₁ₘᵢₙ, k₁ₘₐₓ] to a group of key range q corresponding to the node address of the node 100q.

For the key range 2, k₂ₘₐₓ is contained in the assigned key range of the node 100n. Also, the path management unit 103 stores the key contained in the assigned key range of the node 100n by associating it with the node address of the node 100n. Therefore, by referring to the path management unit 103 for the key range 2, the query forwarding control unit 102 acquires the node address of the node 100n on the basis of k₂ₘₐₓ. Also, the query forwarding control unit 102 acquires a smallest assigned key kₙ₋ₘᵢₙ of the node 100n from the smallest assigned key holding unit 105 on the basis of the node address of the node 100n.

Here, k₁ₘᵢₙ<kₙ₋ₘᵢₙ holds. Therefore, the query forwarding control unit 102 divides the key range 2 [k₁ₘᵢₙ, k₁ₘₐₓ] into a key range 2-1 (816) [k₂ₘᵢₙ, kₙ₋ₘᵢₙ−1] and a key range 2-2 (817) [kₙ₋ₘᵢₙ, k₂ₘₐₓ]. And, the query forwarding control unit 102 appends the key range 2-2 [kₙ₋ₘᵢₙ, k₂ₘₐₓ] to a group of key range n corresponding to the node address of the node 100n. And, the query forwarding control unit 102 performs the same processing as the processing mentioned above for the key range 2-1 [k₂ₘᵢₙ, kₙ₋ₘᵢₙ−1].

For the key range 2-1, kₙ₋ₘᵢₙ−1 is contained in the assigned key range of the node 100m. Also, the path management unit 103 stores the key contained in the assigned key range of the node 100m by associating it with the node address of the node 100q. Therefore, by referring to the path management unit 103 for the key range 2-1, the query forwarding control unit 102 acquires the node address of the node 100q on the basis of kₙ₋ₘᵢₙ−1. Also, the query forwarding control unit 102 acquires the smallest assigned key k_{q-min} of the node 100q from the smallestassigned key holding unit 105 on the basis of the node address of the node 100q.

Here, k₂ min<k_{q-min} does not hold. Therefore, the query forwarding control unit 102 appends the key range 2-1 [k₂ₘᵢₙ, kₙ₋ₘᵢₙ−1] to the group of key range q corresponding to the node address of the node 100q.

Similarly, the query forwarding control unit 102 appends the key range 3 to the group of key range n corresponding to the node address of the node 100n. As for a process in which the query forwarding control unit 102 appends the key range 3 to the group of key range n is similar to the example mentioned above. Accordingly, its description will be omitted.

Next, the query forwarding control unit 102 sends the query and the group of key range q {key range 1, key range 2-1} to the node address of the node 100q. Also, the query forwarding control unit 102 sends the query and the group of key range n {key range 2-2, key range 3} to the node address of the node 100n.

The query forwarding control unit 102 of the node 100q receives the query and the key range group {key range 1, key range 2-1} from the node 100j. The key range 1 is contained completely in the assigned key range of the node 100q. Accordingly, the query forwarding control unit 102 sends the query to the query processing unit 104 and deletes the key range 1 from the key range group. And, the query forwarding control unit 102 acquires a pair of the node address and the group of key range from the key range group {key range 2-1}. Explanation of the following processing which acquires a pair of the group of key range and the node address will be omitted.

By performing such processing, finally, the query is forwarded appropriately so that the desired query may be inputted to the query processing unit 104 of the nodes 100q, 100m and 100n.

The information processing system 10 according to this exemplary embodiment collects, among the key range groups formed from the query, the key range groups of which the node of the next forwarding destination is same as a group of key range. The information processing system 10 forwards the group of key range to the node. For example, referring to FIG. 13, the node 100b forwards collectively the key range 1, the key range 2 and the key range 3 to the node 100j which is the next forwarding destination node. On the other hand, the technology disclosed in NPL 1 forwards each key range from the node 100b to the node 100j. Accordingly, according to the technology of NPL 1, communication from the node 100b to the node 100j will be performed 3 times. On the other hand, according to the information processing system 10 of this exemplary embodiment, the query which is forwarded between the nodes does not pass the same node twice or more.

In Step B607, the information processing system 10 regards the key range [kₘᵢₙ, k−1] as [kₘᵢₙ, kₘₐₓ], and the processing returns to Step B602. This processing is repeated with respect to each key range. Therefore, no more than one group of key range is associated with each node address. No more than one group of key range and the query are sent to one apparatus. In other words, the query which is forwarded between the nodes does not pass the same node twice or more.

By such reduction of redundancy, according to the information processing system 10 of this exemplary embodiment, it is possible to reduce the processing load for forwarding the query in each node.

Also, the information processing system 10 according to this exemplary embodiment divides, with respect to each key range generated from the query, the key range so that the forwarding destination node which is acquired from each key contained in the key range may become same. And, the information processing system 10 collects them with respect to each divided key range into the group of key range. Referring to FIG. 13, the node 100j receives the key range 1, the key range 2 and the key range 3. And, the node 100j divides the key range 2 into the key range 2-1 of which the forwarding destination is the node 100q and the key range 2-2 of which the forwarding destination is the node 100n. And, the query forwarding control unit 102 of the node 100j handles the key range 2-2 and the key range 3 of which the forwarding destination is the node 100n as one group such as the group of key range n. And, the query forwarding control unit 102 forwards the group of key range n to the node 100n. On the other hand, in the technology disclosed by NPL 1, forwarding of the query from the node 100j to the node 100q is performed twice. Further, in the technology disclosed by NPL 1, the identical query reaches the node 100n twice. According to the information processing system 10 of this exemplary embodiment, the problem that the group of key range n is notified to the node 100 doubly via different paths is solved.

By such reduction of redundancy, according to the information processing system 10 of this exemplary embodiment, it is possible to reduce the processing load for forwarding the query in each node.

The information processing system 10 of this exemplary embodiment can reduce redundant processing at the time of query processing. And, the information processing system 10 of this exemplary embodiment can, in case of processing large volumes of queries, get a higher performance compared with the technology, for example, disclosed by NPL 1.

### Second Exemplary Embodiment

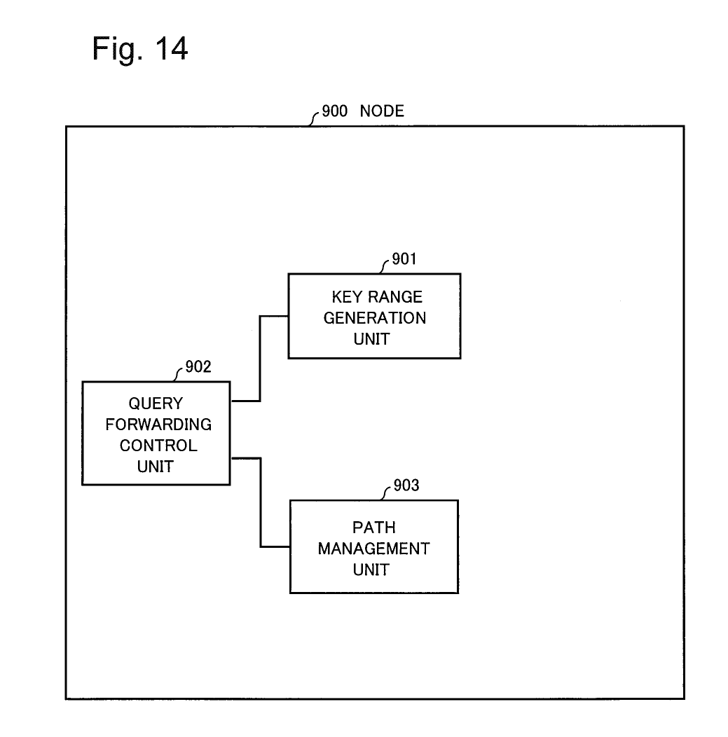

FIG. 14 is a block diagram which indicates a structure of a node 900 according to the second exemplary embodiment of the present invention.

Referring to FIG. 14, the node 900 according to the second exemplary embodiment of the present invention includes a key range generation unit 901, a query forwarding control unit 902 and a path management unit 903. The node 900 forwards a query to process data.

The key range generation unit 901 receives a query which specifies a certain value range. And, the key range generation unit 901 generates keys which indicate values which are contained in the received query respectively. The key is information which indicates at least a certain value. And, the key range generation unit 901 generates a key range group which contains at least one key range which is a set of prescribed keys.

The path management unit 903 stores a key which indicates bounds of the keys to be managed by each apparatus.

The query forwarding control unit 902 receives the key range group from other node 900 or the key range generation unit 901. And, the query forwarding control unit 902 performs the following processing with respect to each key range contained in the received key range group. That is, the query forwarding control unit 902 sends the prescribed key contained in the key range to the path management unit 903. The path management unit 903 specifies one key which is an address key on the basis of the magnitude relation between the value indicated by the key received from the query forwarding control unit 902 and the values indicated by each stored key respectively. The query forwarding control unit 902 receives the address key which the path management unit 903 specifies from the path management unit 903. And, the query forwarding control unit 902 appends the key contained in the key range of target to a group of key range which is a set of keys associated with a node identifier of an apparatus identified on the basis of the value of the address key received from the path management unit 903.

Also, the query forwarding control unit 902 forwards each group of key range to the apparatus which is identified by the node identifier associated with each of the group of key range respectively.

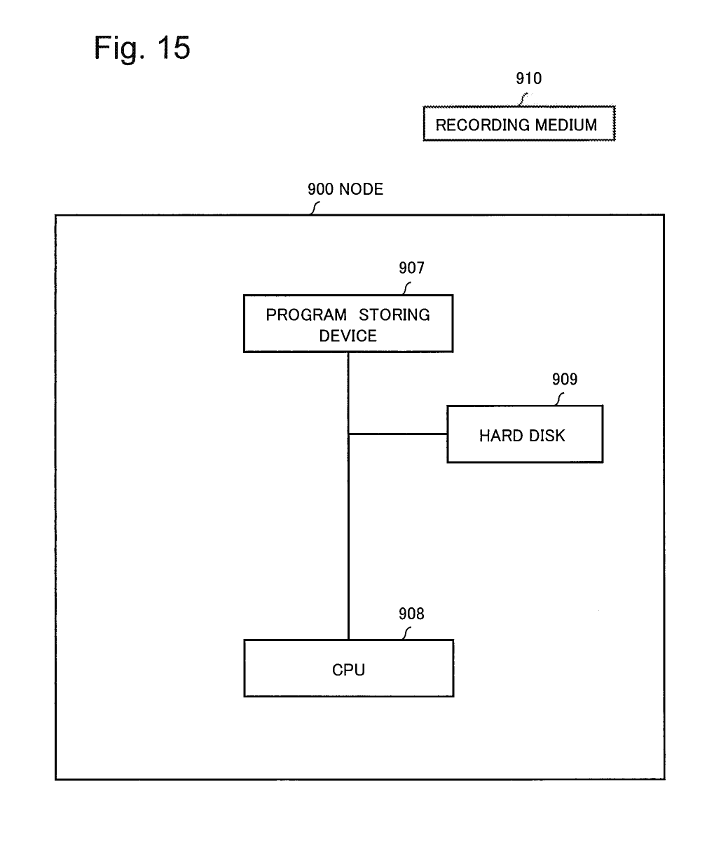

The key range generation unit 901, the query forwarding control unit 902 and the path management unit 903 are realized, for example, by a CPU which operates by a program (information processing program). The key range generation unit 901, the query forwarding control unit 902 and the path management unit 903 may be realized by the identical CPU. In this case, the program is, for example, stored in a program storing device 907 (refer to FIG. 15) included in the node 900. A CPU 908 may read the program and operate as the key range generation unit 901, the query forwarding control unit 902 and the path management unit 903 following the program.

Also, by storage medium (or recording medium) in which a code of the program mentioned above is recorded being supplied to the node 900, the node 900 may read and execute the code of the program stored in the recording medium. That is, the present invention also includes a recording medium 910 which stores temporarily or stores permanently software (information processing program) for the node 900 according to the first exemplary embodiment to execute.

The path management unit 903 is also realized, for example, by a storage device such as a hard disk 909.

By such a structure, the node 900 according to this exemplary embodiment can reduce redundant query processing when large volumes of queries are processed.

As above, each exemplary embodiment described so far is a preferred exemplary embodiment of the present invention, and the scope of the present invention is not limited to only the exemplary embodiments mentioned above. It is possible with respect to each exemplary embodiment to be implemented as the embodiments to which various changes are performed to the extent which does not deviate from the scope of the present invention.

In each exemplary embodiment of the present invention, the node 100 and the node 900 are included in the information processing apparatus or in its part. Accordingly, one node may be composed of one information processing apparatus. Or, one node may be composed so that at least part of the resources such as a memory, a CPU and a hard disk included in the information processing apparatus may be assigned. In other words, a plurality of nodes may be composed of one information processing apparatus.

Although part or all of each exemplary embodiment mentioned above may be described as following supplementary notes, they are not limited to the followings.

(Supplementary Note 1)

An information processing apparatus including: a key range generation unit for receiving a query which specifies a certain value range, generating keys which indicate values contained in the query respectively, and generating a key range group which contains at least one key range which is a set of prescribed keys;

a path management unit for storing a key which indicates bounds of the keys to be managed by each apparatus; and

a query forwarding control unit for receiving the key range group,

specifying, with respect to each key range contained in the key range group, one key which is an address key on the basis of the magnitude relation between the value indicated by a prescribed key contained in the key range and the values indicated by each key which the path management unit stores respectively, and

appending the keys contained in the key range to a group of key range which is a set of keys associated with a node identifier of an apparatus identified on the basis of the value of the address key;

wherein the query forwarding control unit forwards each group of key range to the apparatus which is identified by the node identifier associated with each of the group of key range respectively.

(Supplementary Note 2)

The information processing apparatus described in supplementary note 1, and

the information processing apparatus including: a smallest assigned key holding unit for associating the node identifier and the key, and storing them, wherein

the query forwarding control unit reads, with respect to each key range which is contained in the received key range group,

one key which is associated with the node identifier of the apparatus identified on the basis of the address key from the smallest assigned key holding unit; and

appends a key which indicates a value between the value which the one key indicates and the value which the prescribed key indicates among the keys contained in the key range to the group of key range which is one set associated with the node identifier.

(Supplementary Note 3)

The information processing apparatus described in supplementary note 2, and

the information processing apparatus, wherein the prescribed key is a key which indicates a maximum value among the keys contained in the key range containing the prescribed key.

(Supplementary Note 4)

The information processing apparatus described in supplementary note 3, and

a key which indicates a value which is no less than the value of the smallest assigned key and no more than the value which the prescribed key indicates among the keys contained in the key range to the group of key range which is one set associated with the node identifier.

(Supplementary Note 5)

The information processing apparatus described in supplementary note 4, and

the information processing apparatus, wherein the query forwarding control unit specifies, with respect to each key range which is contained in the received key range group, a key which is contained in the key range, and a key which indicates a value less than the value of the smallest assigned key or more than the value which the prescribed key indicates as a new key range.

(Supplementary Note 6)

The information processing apparatus described in either one of supplementary notes 1 to 5, and the information processing apparatus, wherein the key which the path management unit stores is the node identifier of the corresponding apparatus.

(Supplementary Note 7)

The information processing apparatus described in either one of supplementary notes 1 to 6, and

the information processing apparatus including: an assigned key range storage unit for storing an assigned key range which indicates a set of a certain key; and

a query processing unit for processing queries, wherein

the query forwarding control unit, with respect to each key range which is contained in the received key range group,

divides the key range into a first key range which contains keys overlapping with the assigned key range and a second key range which contains keys not overlapping, and deletes the first key range; and

the query processing unit processes the queries when the query forwarding control unit deletes the first key range.

(Supplementary Note 8)

An information processing system including: at least one information processing apparatus, wherein

the information processing apparatus includes:

a key range generation unit for receiving a query which specifies a certain value range, generating keys which indicate values contained in the query respectively, and generating a key range group which contains at least one key range which is a set of prescribed keys;

a path management unit for storing a key which indicates bounds of the keys to be managed by each information processing apparatus; and a query forwarding control unit for receiving the key range group, specifying, with respect to each key range contained in the key range group,

one key which is an address key on the basis of the magnitude relation between the value indicated by a prescribed key contained in the key range and the values indicated by each key which the path management unit stores respectively, and

appending the keys contained in the key range to a group of key range which is a set of keys associated with a node identifier of an information processing apparatus identified on the basis of the value of the address key; wherein the query forwarding control unit forwards each group of key range to the information processing apparatus which is identified by the node identifier associated with each of the group of key range respectively.

(Supplementary Note 9)

The information processing system described in supplementary note 8, and

the information processing system, wherein the information processing apparatus includes

a smallest assigned key holding unit for associating the node identifier and the key, and storing them; and

the query forwarding control unit reads, with respect to each key range which is contained in the received key range group,

one key which is associated with the node identifier of the apparatus identified on the basis of the address key from the smallest assigned key holding unit, and

appends a key which indicates a value between the value which the one key indicates and the value which the prescribed key indicates among the keys contained in the key range to the group of key range which is one set associated with the node identifier.

(Supplementary Note 10)

The information processing system described in supplementary note 9, and the information processing system, wherein the prescribed key is a key which indicates a maximum value among the keys contained in the key range containing the prescribed key.

(Supplementary Note 11)

The information processing system described in supplementary note 10, and

the information processing system, wherein the smallest assigned key holding unit associates the node identifier and a smallest assigned key which is a key which indicates a smallest value among the keys to be managed by the apparatus identified by the node identifier, and stores them; and the query forwarding control unit appends, with respect to each key range which is contained in the received key range group,

a key which indicates a value which is no less than the value of the smallest assigned key and no more than the value which the prescribed key indicates among the keys contained in the key range to the group of key range which is one set associated with the node identifier.

(Supplementary Note 12)

The information processing system described in supplementary note 11, and

the information processing system, wherein the query forwarding control unit specifies, with respect to each key range which is contained in the received key range group, a key which is contained in the key range, and a key which indicates a value less than the value of the smallest assigned key or more than the value which the prescribed key indicates as a new key range.

(Supplementary Note 13)

The information processing system described in either one of supplementary notes 8 to 12, and

the information processing system, wherein the key which the path management unit stores is the node identifier of the corresponding apparatus.

(Supplementary Note 14)

The information processing system described in either one of supplementary notes 8 to 13, and

the information processing system, wherein the information processing apparatus includes:

an assigned key range storage unit for storing an assigned key range which indicates a set of a certain key; and

a query processing unit for processing queries, wherein

the query forwarding control unit, with respect to each key range which is contained in the received key range group,

divides the key range into a first key range which contains keys overlapping with the assigned key range and a second key range which contains keys not overlapping, and deletes the first key range; and

the query processing unit processes the queries when the query forwarding control unit deletes the first key range.

(Supplementary Note 15)

An information processing method which: receives a query which specifies a certain value range, generates keys which indicate values contained in the query respectively, generates a key range group which contains at least one key range which is a set of prescribed keys,

stores a key which indicates bounds of the keys to be managed by each apparatus in a path management unit,

receives the key range group, specifies, with respect to each key range contained in the key range group,

one key which is an address key on the basis of the magnitude relation between the value indicated by a prescribed key contained in the key range and the values indicated by each key which is stored in the path management unit respectively,

appends the keys contained in the key range to a group of key range which is a set of keys associated with a node identifier of an apparatus identified on the basis of the value of the address key, and

forwards each group of key range to the apparatus which is identified by the node identifier associated with each of the group of key range respectively.

(Supplementary Note 16)

The information processing method described in supplementary note 15, and

the information processing method which: associates the node identifier and the key, and stores them in a smallest assigned key holding unit;

reads, with respect to each key range which is contained in the received key range group,

one key which is associated with the node identifier of the apparatus identified on the basis of the address key from the smallest assigned key holding unit; and

appends a key which indicates a value between the value which the one key indicates and the value which the prescribed key indicates among the keys contained in the key range to the group of key range which is one set associated with the node identifier.

(Supplementary Note 17)

The information processing method described in supplementary note 16, and

the information processing method, wherein the prescribed key is a key which indicates a maximum value among the keys contained in the key range containing the prescribed key.

(Supplementary Note 18)

The information processing method described in supplementary note 17, and

the information processing method which: associates the node identifier and a smallest assigned key which is a key which indicates a smallest value among the keys to be managed by the apparatus identified by the node identifier, and stores them in the smallest assigned key holding unit; and appends, with respect to each key range which is contained in the received key range group,

a key which indicates a value which is no less than the value of the smallest assigned key and no more than the value which the prescribed key indicates among the keys contained in the key range to the group of key range which is one set associated with the node identifier.

(Supplementary Note 19)

The information processing method described in supplementary note 18, and

the information processing method which specifies, with respect to each key range which is contained in the received key range group, a key which is contained n the key range, and a key which indicates a value less than the value of the smallest assigned key or more than the value which the prescribed key indicates as a new key range.

(Supplementary Note 20)

The information processing method described in either one of supplementary notes 15 to 19, and

the information processing method, wherein the key which is stored in the path management unit is the node identifier of the corresponding apparatus.

(Supplementary Note 21)

The information processing method described in either one of supplementary notes 15 to 20, and

the information processing method which: stores an assigned key range which indicates a set of a certain key in an assigned key range storage unit;

with respect to each key range which is contained in the received key range group,

divides the key range into a first key range which contains keys overlapping with the assigned key range and a second key range which contains keys not overlapping; deletes the first key range; and

processes the queries when the query forwarding control unit deletes the first key range.

(Supplementary Note 22)

An information processing program which makes a computer execute:

processing for receiving a query which specifies a certain value range, generating keys which indicate values contained in the query respectively, and generating a key range group which contains at least one key range which is a set of prescribed keys;

processing for storing a key which indicates bounds of the keys to be managed by each apparatus in a path management unit;

processing for receiving the key range group, and specifying, with respect to each key range contained in the key range group,

one key which is an address key on the basis of the magnitude relation between the value indicated by a prescribed key contained in the key range and the values indicated by each key which is stored in the path management unit respectively;

processing for appending the key contained in the key range to a group of key range which is a set of keys associated with a node identifier of an apparatus identified on the basis of the value of the address key; and processing for forwarding each group of key range to the apparatus which is identified by the node identifier associated with each of the group of key range respectively.

(Supplementary Note 23)

The information processing program described in supplementary note 22, and

the information processing program which makes the computer execute:

processing for associating the node identifier and the key, and storing them in a smallest assigned key holding unit;

processing for reading, with respect to each key range which is contained in the received key range group,

one key which is associated with the node identifier of the apparatus identified on the basis of the address key from the smallest assigned key holding unit; and

processing for appending a key which indicates a value between the value which the one key indicates and the value which the prescribed key indicates among the keys contained in the key range to the group of key range which is one set associated with the node identifier.

(Supplementary Note 24)

The information processing program described in supplementary note 23, and

the information processing program, wherein the prescribed key is a key which indicates a maximum value among the keys contained in the key range containing the prescribed key.

(Supplementary Note 25)

The information processing program described in supplementary note 24, and

the information processing program which makes the computer execute:

processing for associating the node identifier and a smallest assigned key which is a key which indicates a smallest value among the keys to be managed by the apparatus identified by the node identifier, and storing them in the smallest assigned key holding unit; and

processing for appending, with respect to each key range which is contained in the received key range group,

a key which indicates a value which is no less than the value of the smallest assigned key and no more than the value which the prescribed key indicates among the keys contained in the key range to the group of key range which is one set associated with the node identifier.

(Supplementary Note 26)

The information processing program described in supplementary note 25, and

The information processing program which makes the computer execute:

processing for specifying, with respect to each key range which is contained in the received key range group, a key which is contained in the key range, and a key which indicates a value less than the value of the smallest assigned key or more than the value which the prescribed key indicates as a new key range.

(Supplementary Note 27)

The information processing program described in either one of supplementary notes 22 to 26, and

the information processing program, wherein the key which is stored in the path management unit is the node identifier of the corresponding apparatus.

(Supplementary Note 28)

The information processing program described in either one of supplementary notes 22 to 27, and

the information processing program which makes the computer execute:

processing for storing an assigned key range which indicates a set of a certain key in an assigned key range storage unit;

processing, with respect to each key range which is contained in the received key range group,

for dividing the key range into a first key range which contains keys overlapping with the assigned key range and a second key range which contains keys not overlapping and deleting the first key range; and processing for processing the queries when the query forwarding control unit deletes the first key range.

(Supplementary Note 29)

A recording medium which stores an information processing program which makes a computer execute:

processing for receiving a query which specifies a certain value range, generating keys which indicates values contained in the query respectively, and generating a key range group which contains at least one key range which is a set of prescribed keys;

processing for storing a key which indicates bounds of the keys to be managed by each apparatus in a path management unit; processing for receiving the key range group, and specifying, with respect to each key range contained in the key range group, one key which is an address key on the basis of the magnitude relation between the value indicated by a prescribed key contained in key range and the values indicated by each key which is stored in the path management unit respectively;

processing for appending the key contained in the key range to a group of key range which is a set of keys associated with a node identifier of an apparatus identified on the basis of the value of the address key; and processing for forwarding each group of key range to the apparatus which is identified by the node identifier associated with each of the group of key range respectively.

This application claims priority based on Japanese Patent Application No. 2011-012946 filed on Jan. 25, 2011 and the disclosure thereof is incorporated herein in its entirety.

### INDUSTRIAL APPLICABILITY

The information processing system of the present invention can be applied to a system of Publish/Subscribe type which sends data (event) which is generated in large volumes from a device such as an RFID (Radio Frequency IDentification) and a sensor to an application which requests it.

### REFERENCE SIGNS LISTS

10 Information processing system
100, 900 Node
101, 901 Key range generation unit
102, 902 Query forwarding control unit
104 Query processing unit
103, 903 Path management unit
105 Smallest assigned key holding unit
106 Assigned key range storage unit
107, 907 Program storing device
108, 908 CPU
109, 909 Hard disk
110, 910 Recording medium
801 Key space
802 Key range
803 Key
804 Attribute space
805 Query area
806, 807, 808 Smallest assigned key table
809 Message
810 Query
811 Key range
812 Smallest key
813 Largest key
814 Key range 1
815 Key range 2
816 Key range 2-1
817 Key range 2-2
818 Key range 3
825 Finger table

1. An information processing apparatus comprising:
key range generation unit which receives a query which specifies a certain value range, generates keys each of which indicates corresponding value which is in the range of the certain value range, and generates a key range group which contains at least one key range which is a set of prescribed keys;
path management unit which stores a key which indicates bounds of the keys to be managed by each apparatus; and
query forwarding control unit which receives the key range group,
specifies with respect to each key range contained in the key range group, one key which is an address key on the basis of the magnitude relation between the value indicated by a prescribed key contained in the key range and the values indicated by each key which the path management unit stores, and
appends the keys contained in the key range to a group of key range which is a set of keys each of which associated with a node identifier of an apparatus identified on the basis of the value of the address key;
wherein the query forwarding control unit forwards each group of key range to a corresponding apparatus which is identified by the node identifier associated with each of the group of key range respectively.

2. The information processing apparatus according to claim 1, further comprising:
smallest assigned key holding unit which associates the node identifier and the key, and storing them,
wherein the query forwarding control unit reads, with respect to each key range which is contained in the received key range group, one key which is associated with the node identifier of the apparatus identified on the basis of the address key from the smallest assigned key holding unit, and
appends a key which indicates a value between the value which the one key indicates and the value which the prescribed key indicates among the keys contained in the key range to the group of key range which is one set associated with the node identifier.

3. The information processing apparatus according to claim 2, wherein the prescribed key is a key which indicates a maximum value among the keys contained in the key range containing the prescribed key.

4. The information processing apparatus according to claim 3, wherein the smallest assigned key holding unit associates the node identifier and a smallest assigned key which is a key which indicates a smallest value among the keys to be managed by the apparatus identified by the node identifier, and stores them; and
wherein the query forwarding control unit appends, with respect to each key range which is contained in the received key range group, a key which indicates a value which is no less than the value of the smallest assigned key and no more than the value which the prescribed key indicates among the keys contained in the key range to the group of key range which is one set associated with the node identifier.

5. The information processing apparatus according to claim 4, wherein the query forwarding control unit specifies, with respect to each key range which is contained in the received key range group, a key which is contained in the key range, and which indicates a value less than the value of the smallest assigned key or more than the value which the prescribed key indicates as a new key range.

6. The information processing apparatus according to claim 1, wherein the key which the path management unit stores is the node identifier of the corresponding apparatus.

7. The information processing apparatus according to claim 1,
further comprising: assigned key range storage unit which stores an assigned key range which indicates a set of a certain key; and
query processing unit which processes queries, wherein
the query forwarding control unit, with respect to each key range which is contained in the received key range group, divides the range into a first key range which contains keys overlapping with the assigned key range and a second key range which contains keys not overlapping, and deletes the first key range; and
wherein the query processing unit processes the queries when the query forwarding control unit deletes the first key range.

8. An information processing system comprising: at least one information processing apparatus, wherein
the information processing apparatus comprises:
key range generation unit which receives a query which specifies a certain value range, generating keys which indicate values contained in the query respectively, and generating a key range group which contains at least one key range which is a set of prescribed keys;
path management unit which stores a key which indicates bounds of the keys to be managed by each information processing apparatus; and
query forwarding control unit which receives the key range group, specifying, with respect to each key range contained in the key range group,
one key which is an address key on the basis of the magnitude relation between the value indicated by a prescribed key contained in the key range and the values indicated by each key which the path management unit stores, and
appending the keys contained in the key range to a group of key range which is a set of keys each of which associated with a node identifier of an information processing apparatus identified on the basis of the value of the address key; wherein
the query forwarding control unit forwards each group of key range to the information processing apparatus which is identified by the node identifier associated with each of the group of key range respectively.

9. An information processing method comprising:
receiving a query which specifies a certain value range, generating keys which indicate values contained in the query respectively,
generating a key range group which contains at least one key range which is a set of prescribed keys,
storing a key which indicates bounds of the keys to be managed by each apparatus in path management unit,
receiving the key range group,
specifying, with respect to each key range contained in the key range group, one key which is an address key on the basis of the magnitude relation between the value indicated by a prescribed key contained in the key range and the values indicated by each key which is stored in the path management unit,
appending the keys contained in the key range to a group of key range which is a set of keys each of which associated with a node identifier of an apparatus identified on the basis of the value of the address key, and
forwarding each group of key range to the apparatus which is identified by the node identifier associated with each of the group of key range respectively.

10. A recording medium which stores an information processing program which makes a computer executes:
processing for receiving a query which specifies a certain value range, generating keys which indicates values contained in the query respectively, and generating a key range group which contains at least one key range which is a set of prescribed keys;
processing for storing a key which indicates bounds of the keys to be managed by each apparatus in path management unit;
processing for receiving the key range group, and
specifying, with respect to each key range contained in the key range group, one key which is an address key on the basis of the magnitude relation between the value indicated by a prescribed key contained in the key range and the values indicated by each key which is stored in the path management unit;
processing for appending the key contained in the key range to a group of key range which is a set of keys each of which associated with a node identifier of an apparatus identified on the basis of the value of the address key; and
processing for forwarding each group of key range to the apparatus which is identified by the node identifier associated with each of the group of key range respectively.

11. An information processing apparatus comprising:
key range generation unit for receiving a query which specifies a certain value range, generating keys each of which indicates corresponding value which is in the range of the certain value range, and generating a key range group which contains at least one key range which is a set of prescribed keys;
path management unit for storing a key which indicates bounds of the keys to be managed by each apparatus; and
query forwarding control unit for receiving the key range group,
specifying, with respect to each key range contained in the key range group, one key which is an address key on the basis of the magnitude relation between the value indicated by a prescribed key contained in the key range and the values indicated by each key which the path management unit stores, and
appending the keys contained in the key range to a group of key range which is a set of keys each of which associated with a node identifier of an apparatus identified on the basis of the value of the address key;
wherein the query forwarding control unit forwards each group of key range to a corresponding apparatus which is identified by the node identifier associated with each of the group of key range respectively.
